(19) United States
(12) Patent Application Publication
(10) Pub. No.: US 2025/0137973 A1
(43) Pub. Date: May 1, 2025

(54) FREE HAND ACOUSTIC PROBE TRACKING

(71) Applicant: Evident Canda, Inc., Québec (CA)

(72) Inventor: Alain Le Duff, Québec (CA)

(21) Appl. No.: 18/703,199

(22) PCT Filed: Oct. 21, 2022
(86) PCT No.: PCT/CA2022/051557

§ 371 Date: Apr. 19, 2024

Related U.S. Application Data
(60) Provisional application No. 63/262,857, filed on Oct. 21, 2021.

(51) Int. Cl. G01N 29/22; G01N 29/04; G01N 29/265

(52) U.S. Cl. CPC G01N 29/226; G01N 29/04; G01N 29/265; G01N 2291/0289

(57) ABSTRACT

The present subject relates generally to acoustic inspection probe guidance or tracking, such as facilitating free-hand scanning of an acoustic probe assembly for performing acoustic inspection. For example, using an acoustic inspection probe assembly, an acoustic telemetry signal can be transmitted, such as separately from acoustic pulses or echoes used for acoustic inspection. Using at least one electroacoustic receiver, the acoustic telemetry signal can be received and using the received representation of the acoustic telemetry signal, at least one of (1) a position of the acoustic probe assembly relative to a reference position or (2) an orientation of the acoustic probe assembly in relation to a reference orientation can be determined. An indicium can be provided to a user indicative of at least one of (1) the determined position or (2) the determined orientation.

### CLAIM OF PRIORITY

This patent application claims the benefit of priority of Alain Le Duff, U.S. Provisional Patent Application Ser. No. 63/262,857, titled “FREE HAND ACOUSTIC PROBE TRACKING,” filed on Oct. 21, 2021, which is hereby incorporated by reference herein in its entirety.

### FIELD OF THE DISCLOSURE

This document pertains generally, but not by way of limitation, to apparatus and techniques for non-destructive inspection such as facilitating acoustic inspection, and more particularly, to apparatus and techniques facilitating tracking of probe assembly position, such as to facilitate acoustic scanning in a free-hand manner.

### BACKGROUND

Non-destructive testing (NDT) can refer to use of one or more different techniques to inspect regions on or within an object, such as to ascertain whether flaws or defects exist, or to otherwise characterize the object being inspected. Examples of non-destructive test approaches can include use of an eddy-current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity.

Another approach for NDT can include use of an acoustic inspection technique, such as where one or more electroacoustic transducers are used to insonify a region on or within the object under test, and acoustic energy that is scattered or reflected can be detected and processed. Such scattered or reflected energy can be referred to as an acoustic echo signal. Generally, such an acoustic inspection scheme involves use of acoustic frequencies in an ultrasonic range of frequencies, such as including pulses having energy in a specified range that can include value from, for example, a few hundred kilohertz, to tens of megahertz, as an illustrative example.

As discussed further below, acoustic inspection can be carried out using a probe assembly, where the probe assembly is in communication with a test instrument or other apparatus. The probe assembly can include an electroacoustic transducer, or an array of such transducers. To achieve desired coverage of an object under test, the probe assembly is generally moved relative to the object along a specified scan path. In one approach, movement can be facilitated by fixtures, automated, or semi-automated scanners, such as constraining probe movement along a specified scan path.

### SUMMARY OF THE DISCLOSURE

Non-destructive test (NDT) can include apparatus and techniques for inspecting various objects, such as using optical, acoustic, or electromagnetic techniques, or combinations thereof. As mentioned above, in one approach, an acoustic probe assembly can be used to perform inspection of an object, where the probe is moved relative to the object along a scan path to achieve specified inspection coverage. The present inventor has recognized, among other things, that planning and executing an inspection operation can present various challenges, particularly in relation to mechanical scanning of an acoustic probe assembly. Generally, if a complex object is being inspected, setting up a scan plan, establishing a related scan path, and performing one or more corresponding acoustic inspection acquisitions can each be challenging.

For example, once a scan plan is established, establishing the actual scan path to be used for acquisition may involve measuring and marking or inscribing the object under test to provide a path to follow for an operator of the inspection equipment. Such setup may also involve setting up fixturing that is anchored to the object under test and the probe assembly to constrain or guide probe assembly movement. Such fixturing may need to be customized for each structure being inspected, because the geometry of the structures being scanned may vary from one structure to another. During acquisition, various techniques can be used to perform spatial encoding of movement of the probe assembly for tracking, such as using wheels or other structures to encode movement. Such mechanical encoding techniques can present challenges such as providing encoding in limited axes (or even just one axis), being subject to slippage or binding, or other sources of inaccuracy. The present inventor has also recognized that even if an operator is able to guide a probe assembly along a desired scan path, either free-hand or using fixturing, other sources of error such as errors in probe orientation or elevation can still introduce errors in an acoustic inspection acquisition, affecting inspection productivity or detectability of defects or flaws. Other approaches for probe assembly tracking can be used, such as optical (e.g., laser or visible-light imaging), but such approaches can present separate challenges such as cost, sensitivity to environmental conditions, or insufficient resolution.

To address one or more of the challenges above, the present inventor has developed apparatus and techniques as described herein, such as can provide guidance to an operator concerning one or more of probe indexing, probe orientation (e.g., skew), or probe elevation, or combinations thereof. The apparatus and techniques described herein can include use of an acoustic telemetry scheme, such as where signals transmitted and received by ultrasonic transducers can be used for determination of probe assembly orientation or position to provide tracking data or guidance information to an operator. Such guidance can include one or more visual indicators located on or nearby a probe assembly, such as to allow the operator to keep their attention on the probe assembly and the object under test. Such techniques can be used to facilitate a free-hand inspection approach, simplifying or even eliminating fixturing or other scanning equipment that would otherwise be used to constrain or control probe assembly movement. The apparatus and techniques herein are applicable to a variety of inspection scenarios, such as acoustic inspection of welds used in fabricating joints for nozzle structures or other complex shapes (e.g., branch structures, pressure vessel head or shell nozzles, or other structures).

In an example, an apparatus for acoustic inspection comprises an acoustic probe assembly comprising an electroacoustic inspection transducer configured to transmit acoustic pulses for the acoustic inspection and to receive echoes elicited by the acoustic pulses for the acoustic inspection and an electroacoustic telemetry transducer configured for transmission of an acoustic telemetry signal separate from acoustic pulses or echoes for the acoustic inspection, the electroacoustic telemetry transducer separate from the electroacoustic inspection transducer. The system can include at least one electroacoustic receiver configured to receive the acoustic telemetry signal, a visual indicator, a processor circuit communicatively coupled with the electroacoustic telemetry transducer and the at least one electroacoustic receiver, and a memory circuit comprising instructions that when executed by the processor circuit, cause the processor circuit to, using a received representation of the acoustic telemetry signal, determine at least one of (1) a position of the acoustic probe assembly relative to a reference position or (2) an orientation of the acoustic probe assembly in relation to a reference orientation, and using the visual indicator, present an indicium to a user of at least one of (1) the determined position or (2) the determined orientation. In an example, the at least one electroacoustic receiver comprises an electroacoustic receiver included as a portion of the acoustic probe assembly. In an example, the at least one electroacoustic receiver comprises a plurality of electroacoustic receivers separate from the acoustic probe assembly.

In an example, a technique such as a machine-implemented method for acoustic inspection probe guidance can include, using an acoustic inspection probe assembly, transmitting an acoustic telemetry signal separate from acoustic pulses or echoes used for acoustic inspection and using at least one electroacoustic receiver, receiving the acoustic telemetry signal to provide a received representation of the acoustic telemetry signal. Using the received representation of the acoustic telemetry signal, at least one of (1) a position of the acoustic probe assembly relative to a reference position or (2) an orientation of the acoustic probe assembly in relation to a reference orientation can be determined, and an indicium can be provided to a user of at least one of (1) the determined position or (2) the determined orientation.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising an acoustic inspection system, such as can be used to perform at least a portion one or more techniques as shown and described herein.

FIG. 2 illustrates generally an example comprising an acoustic inspection configuration, such as for performing inspection of a nozzle structure, and showing a nominal scan path and related types of probe tracking error, including positional and orientation errors.

FIG. 3A illustrates generally an example comprising an acoustic inspection configuration, such as including an acoustic probe assembly having an electroacoustic telemetry transducer for transmission of an acoustic telemetry signal, one or more electroacoustic telemetry transducer receivers, and a visual indicator.

FIG. 3B illustrates generally an example similar to FIG. 3A, but with the acoustic probe assembly in a different orientation and position relative to a nominal scan path.

FIG. 4A illustrates generally an example comprising an acoustic inspection configuration, such as including an acoustic probe assembly having an electroacoustic telemetry transducer for transmission of an acoustic telemetry signal, and a separate electroacoustic receiver array.

FIG. 4B illustrates generally an example similar to the acoustic inspection configuration of FIG. 4A, showing an example of a configuration for the separate electroacoustic receiver array extending circumferentially around a structure to be acoustically inspected.

FIG. 4C, FIG. 4D, and FIG. 4E illustrate generally an example of a coordinate system and related parameters that can be used for analysis of the electroacoustic receiver array and acoustic telemetry transmitter, such as showing how electroacoustic probe assembly location parameters can be determined.

FIG. 5A illustrates generally an example comprising a transducer cluster in a modular electroacoustic receiver array.

FIG. 5B illustrates generally an example comprising a modular electroacoustic receiver array including multiple cluster.

FIG. 6 shows a technique, such as a machine implemented method, for determining at least one of a position or an orientation of an acoustic probe assembly.

FIG. 7 illustrates a block diagram of an example comprising a machine upon which any one or more of the techniques (e.g., methodologies) discussed herein may be performed.

### DETAILED DESCRIPTION

Non-destructive testing can be performed using various techniques such as involving acoustic, electromagnetic, or optical scanning. Generally, scanning is performed using a probe assembly that is movable relative to a test specimen (or vice versa), to achieve coverage of a portion or an entirety of the test specimen according to a scan plan. Generally, the scan plan includes establishing one or more scan paths over which an acoustic probe assembly will be moved relative to an object under test. For example, nozzle structures, and associated weld structures, can present various challenges in relation to performing acoustic inspection. Nozzle geometries can vary substantially from each other, such as in terms of radius, thickness, and interface with other tubular structures such as pressure vessels or columns. Nozzle structures can include shell-located and head-located nozzles, such as protruding from a head or sidewall of another structure, either normal (e.g., at a ninety-degree angle), or angled, such as in a direction parallel to a vessel or column center line. Nozzle intersections with other structures can include radial, hill-side, or tangential orientations. Accordingly, weld geometries at such interfaces can form complex shapes, and correspondingly complex scan paths for acoustic inspection. The apparatus and techniques described herein can be used to facilitate a “free hand” approach to performing acoustic inspection, such as without requiring complex scanning fixtures or mechanical encoding, facilitating inspection of different nozzle structures and associated welds.

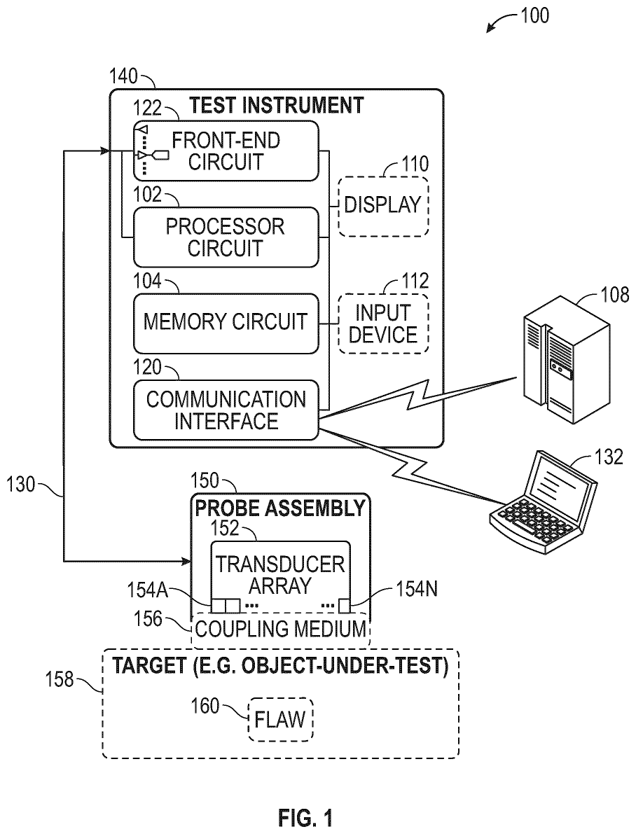

FIG. 1 illustrates generally an example comprising an acoustic inspection system 100, such as can be used to perform at least a portion one or more techniques as shown and described herein. The inspection system 100 can include a test instrument 140, such as a hand-held or portable assembly. The test instrument 140 can be electrically coupled to a probe assembly 150, such as using a multi-conductor interconnect 130. The probe assembly 150 can include one or more electroacoustic transducers, such as a transducer array 152 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly 150 configuration can be used, such as to allow a test instrument 140 to be used with various different probe assemblies. Generally, the transducer array 152 includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 156 during testing, or testing can be conducted with an interface between the probe assembly 150 and the target 158 otherwise immersed in a coupling medium.

The test instrument 140 can include digital and analog circuitry, such as a front-end circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect 130 to a probe assembly 150 for insonification of the target 158, such as to image or otherwise detect a flaw 160 on or within the target 158 structure by receiving scattered or reflected acoustic energy elicited in response to the insonification.

While FIG. 1 shows a single probe assembly 150 and a single transducer array 152, other configurations can be used, such as multiple probe assemblies connected to a single test instrument 140, or multiple transducer arrays 152 used with a single probe assembly 150 or multiple probe assemblies for pitch/catch inspection modes. Similarly, a test protocol can be performed using coordination between multiple test instruments 140, such as in response to an overall test scheme established from a master test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument 140. The processor circuit can be coupled to a memory circuit, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-scan matrices of time-series data or other representations of such data, for example, can be accomplished using remote facilities communicatively coupled to the test instrument 140. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

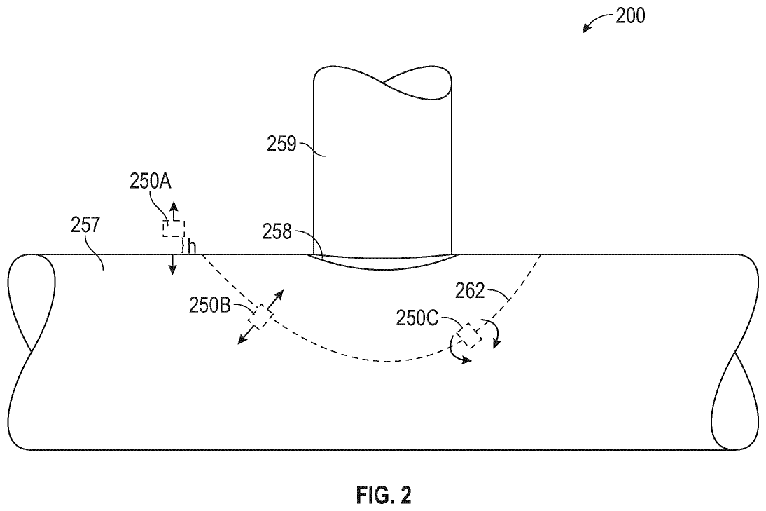

FIG. 2 illustrates generally an example comprising an acoustic inspection configuration 200, such as for performing inspection of a nozzle 259 structure. FIG. 2 shows a nominal scan path 262 and related types of acoustic probe tracking error, including positional and orientation errors. As mentioned above, in one approach, achieving desired probe assembly tracking can involve use of complex mechanical fixturing. If a free-hand or semi-free-hand approach is used, several types of tracking error can occur. One error is variation in acoustic probe assembly 250A height from a nominal height, “h” or elevation. For example, in most acoustic inspection configurations, a couplant medium (e.g., water column) is located between an active surface of the acoustic probe assembly 250A and the structure under test. Beamforming or other techniques may assume a nominal water column height or probe orientation relative to the surface of the structure being inspected, and variation from such a nominal height may impact inspection coverage, decreasing inspection productivity (such as requiring a repeated acquisition). Another tracking error is shown at the acoustic probe assembly 250B location, such as where the acoustic probe assembly 250B is located further away or closer to the structure being inspected (e.g., a weld 258 at an interface between a nozzle 259 and another structure 257 such as a pressure vessel). Such error can be referred to as “index” error. A third type of tracking error is shown at the acoustic probe assembly 250C location, such as where the acoustic probe assembly 250C is rotated relative to a nominal probe orientation. Such error can be referred to as “skew” error. Elevation, index, and skew error can each be detrimental to acoustic inspection productivity, and the apparatus and techniques described herein can help to control one or more of such errors.

As an illustration, performing acoustic inspection related to a nozzle 259 structure, as shown in FIG. 2, can involve maintaining a probe orientation that is 90 degrees offset from the scan path 262 center line (e.g., orienting an active portion of the probe such that a beam direction is toward the weld 258 or nozzle 259). Positioning and orienting of the probe assembly, without fixturing, can be particularly challenging, if scanning is being performed in a free-hand manner, even if the scan path is marked or inscribed on the structure 257. Also, an acoustic scan plan may specify that acoustic inspection acquisitions are performed in a manner that provides a spatially encoded representation of the probe position for acquisition. Various techniques can be used for performing such encoding, such as mechanical encoding using linear or angular encoders, use of an inertial measurement unit (IMU) such as using accelerometers, or optical techniques (laser or video). Each of these approaches can present various drawbacks, such as sensitivity to ambient environment (lighting or surface reflectivity), cumbersomeness, or insensitivity in certain axes or orientations. The present inventor has recognized, among other things, that in addition to such approaches or instead of such approaches, an acoustic telemetry approach can be used. The acoustic telemetry approach can use transducers and acoustic telemetry signaling that are separate from transducers and pulsing used for acoustic inspection. For example, such acoustic telemetry can be implemented using inexpensive transducers that can be mounted on the acoustic probe assembly or elsewhere. For example, acoustic receivers can be on-board the probe assembly or a receiver array can be used that is separate from the acoustic probe assembly. The signaling scheme used for acoustic telemetry can be selected to avoid interference with acoustic inspection acquisition signals, such as having different center frequency, frequency range, or pulse morphology, as discussed below.

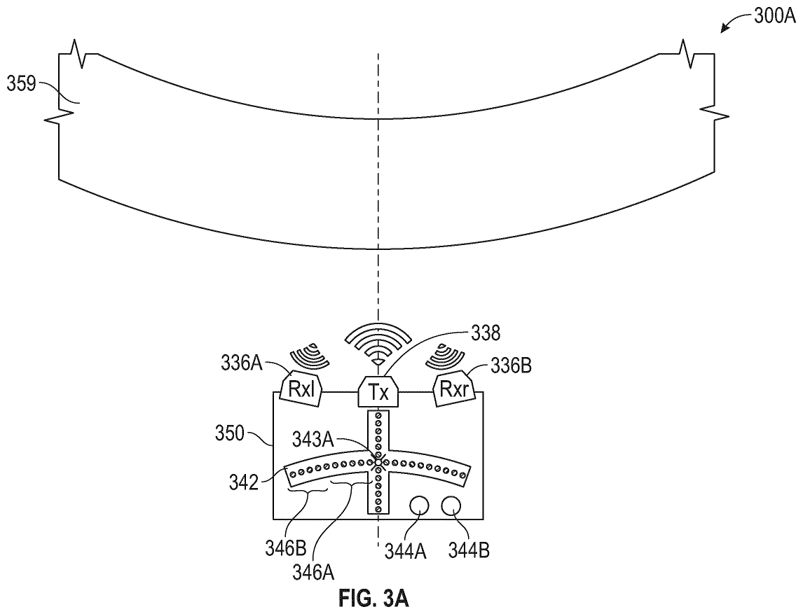

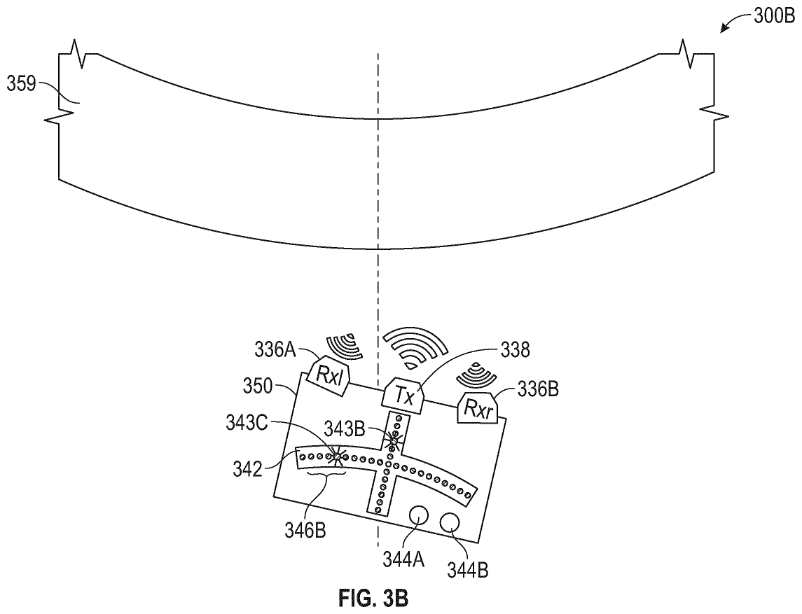

FIG. 3A illustrates generally an example comprising an acoustic inspection configuration 300A, such as including an acoustic probe assembly 350 having an electroacoustic telemetry transducer 338 for transmission of an acoustic telemetry signal, one or more electroacoustic telemetry transducer receivers 336A and 336B, and a visual indicator 342. FIG. 3B illustrates generally an example similar to FIG. 3A, but with the acoustic probe assembly 350 in a different orientation and position relative to a nominal scan path. In FIG. 3A and FIG. 3B, the probe assembly 350 can otherwise be similar to the probe assembly 150 of FIG. 1 but including a visual indicator 342 or other source of feedback for an operator. For example, as shown in the configuration 300A of FIG. 3A, the acoustic probe assembly 350 can use the electroacoustic telemetry transducer 338 to transmit an acoustic telemetry signal toward a target such as a nozzle 359 or other portion of structure being inspected.

One or more receivers 336A or 336B can receive a representation of the acoustic telemetry signal (e.g., an echo reflected off a surface of a target such as the nozzle 359). Using such a received representation (or multiple such representations) one or more of an acoustic probe assembly 350 position or orientation can be determined. For example, if two or more electroacoustic receivers (such as two receivers 336A and 336B) are used, skew and index deviation from a nominal reference position can be estimated. As an illustrative example, the acoustic probe assembly 350 can include one or more user inputs, such as buttons 344A or 344B. For setup or calibration, buttons 344A or 344B can be actuated by a user to trigger establishment of a reference position (e.g., a reference index), such as when button 344A is depressed, or a reference orientation (e.g., a reference skew) when button 344B is pressed. The visual indicator 342 can include a bar or row of display elements, such as defining different regions 346A (e.g., colored red and indicating a high or unacceptable level of deviation) and 346B (e.g., colored yellow and indicating an intermediate level of deviation). The visual indicator 342 can provide an indication of a degree of positional or orientation misalignment before or during an acoustic acquisition without requiring the operator to look away from the acoustic probe assembly 350. A lit indicator 343A at or near the center of the visual indicator 342 can provide feedback to an operator that the acoustic probe assembly 350 position or orientation are well-positioned to start or continue an acoustic inspection. In this manner, the operator need not consult a separate instrument and can keep their attention on the acoustic probe assembly 350 during free-hand movement of the acoustic probe assembly 350.

In the configuration 300B of FIG. 3B, an indicator 343B can indicate that the position of the acoustic probe assembly 350 is in an incorrect position (showing index error where the probe needs to be moved away from the nozzle 359), and an indicator 343C shows that the acoustic probe assembly 350 is in an incorrect orientation (showing a skew error where the probe needs to be rotated counter-clockwise). The use of buttons 344A and 344B, and visual indicator 342 configuration showing regions such as region 346B are merely illustrative examples. Other visual indicators or operator feedback techniques can be used, such as to facilitate providing an operator with position or orientation feedback before or during (e.g., contemporaneously with) an acoustic inspection acquisition. For example, a bit-field display such as a liquid crystal display or LED display can be used, and can include a touch-screen, or buttons located around the display in a “soft key” configuration. Other indicia can include haptic feedback or audio feedback (such as providing vibration or audible pulses indicative of probe tracking error, such as where a count, sequence, or intensity of pulses indicates the nature of the position or orientation error). A location of receivers 336A and 336B relative to each other, or relative to the acoustic telemetry transducer 338, can be adjustable, such as to accommodate different nozzle 359 or other object configurations.

As discussed further below, the acoustic probe assembly 350 can be in communication with other portions of an acoustic inspection system. For example, the acoustic probe assembly 350 can make position or orientation determinations internally or can transmit received data to another device, such as to perform position or location determination elsewhere, or to provide logging of encoded position or orientation determinations. Such logging can include converting such position or orientation determinations into a specified coordinate space or providing simpler data indicative of error such as skew angular error (e.g., deviation from a nominal probe orientation angle). The features shown for the acoustic probe assembly 350 in FIG. 3A and FIG. 3B need not integrally form a portion of such a probe assembly. For example, the features discussed above can be a module that can be mechanically coupled with or secured to an existing acoustic probe assembly, such as to provide an “add-on” acoustic probe tracking capability.

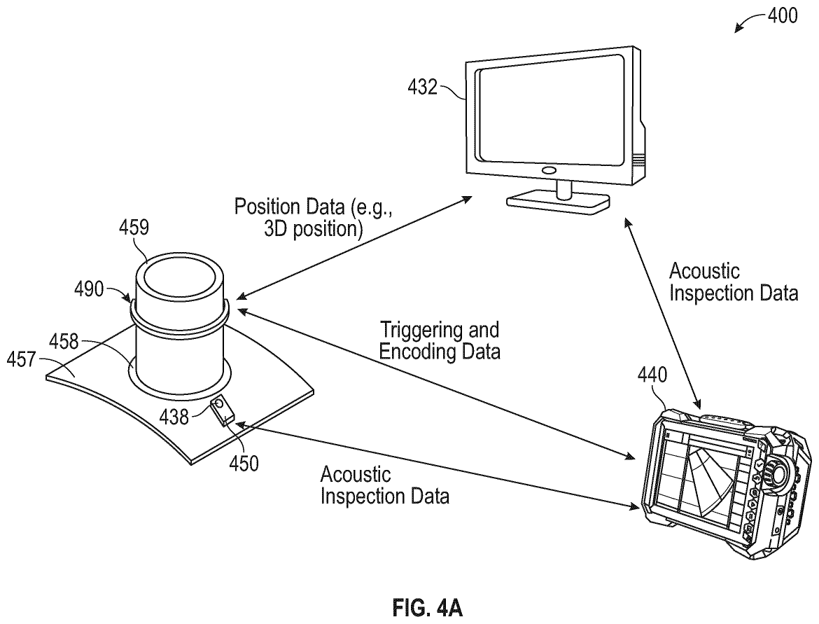

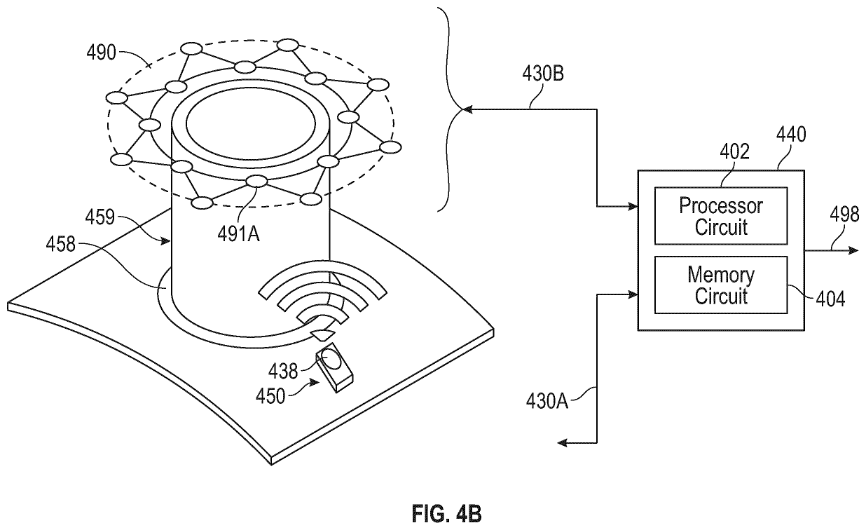

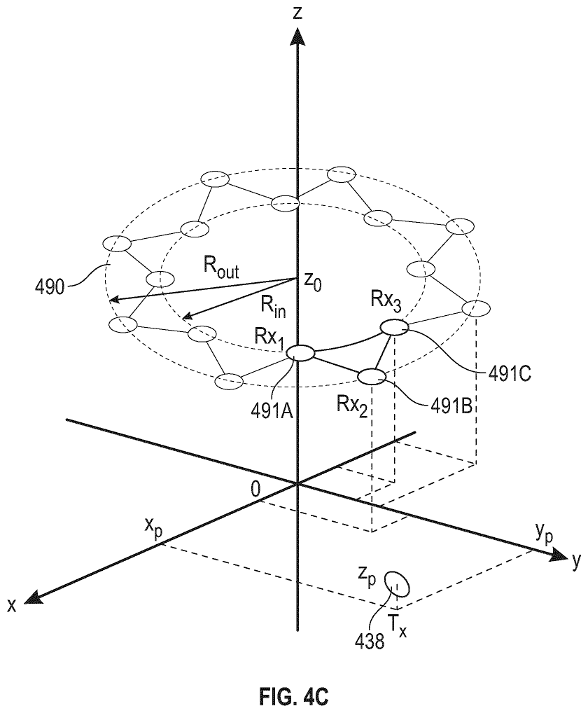

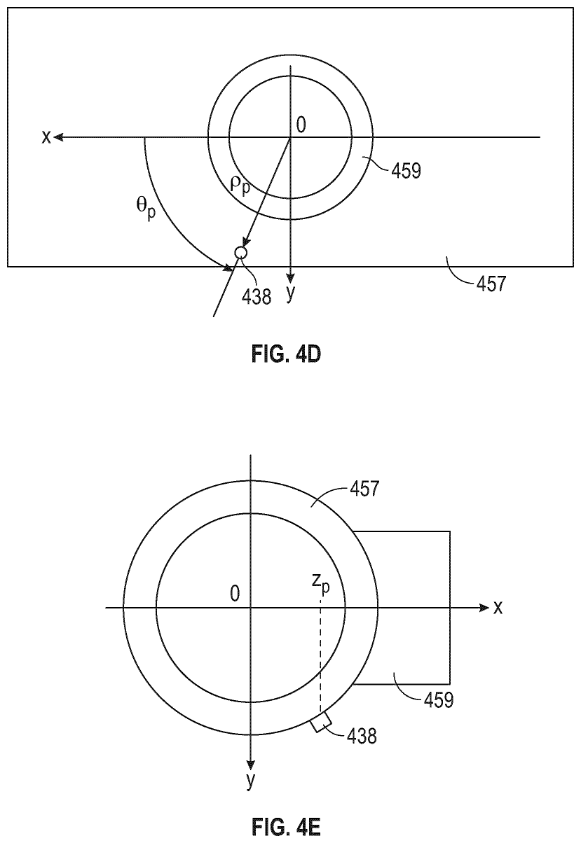

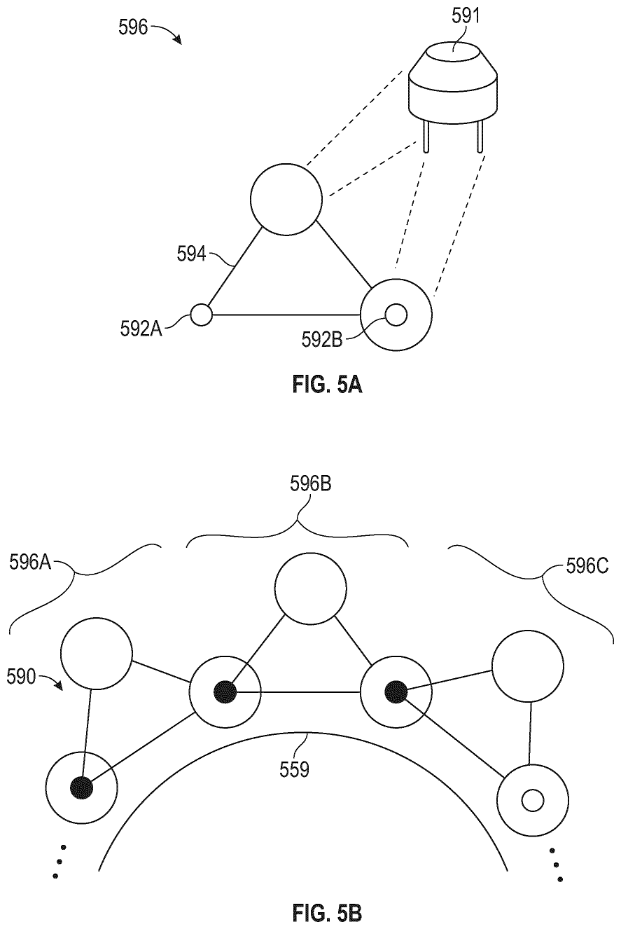

In general, as discussed elsewhere herein, various acoustic signaling methods can be used to implement the acoustic telemetry signal. For example, a differential “pitch”/“catch” approach can be used where time-of-flight or time-of-arrival is determined at respective receivers. A pulse or other signal can be transmitted from the acoustic telemetry transducer 338 at a known time index and the receivers 336A and 336B can provide received representations of echoes or other received representations of the transmitted signal, the received representations indexed to the known time index (e.g., the receivers can operate using a common time base or otherwise in a synchronized manner). Various receive schemes can be used, such as coherent detection, correlation-based approaches such as using a matched receive filter or known pulse profile, or the like. The examples below in FIG. 4A, FIG. 4B, FIG. 4C, FIG. 4D, FIG. 4E, FIG. 5A, and FIG. 5B show an approach where receivers can be used that are separate from an acoustic probe assembly.

FIG. 4A illustrates generally an example comprising an acoustic inspection configuration 400, such as including an acoustic probe assembly 450 having an electroacoustic telemetry transducer 438 for transmission of an acoustic telemetry signal, and a separate electroacoustic receiver array 490 for receiving the acoustic telemetry signal. The configuration 400 can be similar to the system 100 of FIG. 1 but including an acoustic probe assembly 450 having the electroacoustic telemetry transducer 438 and the separate electroacoustic receiver array 490. As in other examples herein, the configuration 400 can be used to perform acoustic inspection of a structure such as a weld 458 at an interface between a nozzle 459 and another structure 457. Tracking of the position or orientation acoustic probe assembly 450 can be performed, such as to guide an operator as in the examples above of FIG. 3A and FIG. 3B (where a visual indicator is presented to the user, such as on-board the acoustic probe assembly 450). The acoustic probe assembly 450 can be in communication with one or more other devices such as a test instrument 440 (e.g., for coordinating acoustic inspection and receiving acquired acoustic inspection data). The receiver array 490 can be in communication with the test instrument 440, such as to provide received representations of a telemetry signal transmitted by the electroacoustic telemetry transducer 438, or to provide encoded position or orientation data, including triggering or suspending logging by the test instrument 440, for example. Position or orientation determinations can be made or logged, for example, by a separate facility such as a tracking computer 432 (e.g., a personal computer, tablet, or dedicated embedded device for performing acoustic probe assembly 450 signal processing relating to tracking), or such facilities can be provided by the test instrument 440.

FIG. 4B illustrates generally an example similar to the acoustic inspection configuration 400 of FIG. 4A, showing an example of a configuration for the separate electroacoustic receiver array 490 extending circumferentially around a structure to be acoustically inspected. In this example, the electroacoustic receiver array 490 comprises respective receive transducer elements, such as an element 491A. The elements can be located in two concentric rings around the circumference of a nozzle 459 structure, such as facilitating tracking of at least one of the acoustic inspection probe assembly 450 position or orientation, before or during an acoustic inspection of a weld 458 or other structure. The acoustic probe assembly 450 can be communicatively coupled via a first link 430A to a test instrument 440 or other facility, such as to transmit acoustic inspection data or to receive information from the test instrument 440. A second link 430B can be used to communicatively couple the electroacoustic receiver array 490 with the test instrument 440 or other facility. The test instrument 440 or other facility can provide a processor circuit 402 and a memory circuit 404, such as including instructions that cause the processor circuit 402 to determine at least one of an acoustic probe assembly 450 position or orientation determination as an output 498, or related data for logging of spatially-encoded acoustic acquisitions. In an example, the processor circuit 402 and the memory circuit 404 can form a portion of an embedded system such as a digital signal processor located at or near the electroacoustic receiver array 490 or the acoustic probe assembly 450, separate from another instrument. The first and second links 430A and 430B can be wired or wireless, such as forming a wired interconnection or a wireless (e.g., radio-frequency or microwave-frequency) link.

FIG. 4C, FIG. 4D, and FIG. 4E illustrate generally an example of a coordinate system and related parameters that can be used for analysis of the electroacoustic receiver array and acoustic telemetry transmitter, such as showing how electroacoustic probe assembly location parameters can be determined. In the illustrative example of FIG. 4B and as shown in FIG. 4C, the electroacoustic receiver array 490 can include two concentric rings of transducer elements, such as defined by an inner radius Rᵢₙ and an outer radius Rₒᵤₜ. A cartesian coordinate system can be defined such as relative to a first element 491A, R_{X1}, and projections are shown with locations of other elements such as a second element 491B, R_{X2}, and a third element 4911, R_{X3}, and so on. Accordingly, the z location, zₒ, of the electroacoustic receiver array 490, the radii Rᵢₙ, Rₒᵤₜ, and the locations of the receive elements Rx₁:(x₁, y₁, z₁); Rx₂:(x₂, y₂, z₂); and Rx₃:(x₃, y₃, z₃) are known. An actual location of an electroacoustic telemetry transducer 438 used for transmission of an acoustic telemetry signal can be annotated as Tₓ:(xₚ, yₚ, zₚ). During free-hand movement of the acoustic probe assembly, the position Tₓ is generally not known, but an estimate of Tₓ can be made using received representations of the acoustic telemetry signal transmitted by the electroacoustic telemetry transducer 438, such as to provide an estimated probe assembly position Tₓ:(\hat{x}ₚ, ŷₚ, \hat{z}ₚ). Referring to FIG. 4D ad FIG. 4E, the determined position (or a series of such determinations) can assist in determining a probe orientation. The estimated probe position Tₓ:(\hat{x}ₚ, ŷₚ, \hat{z}ₚ) can also be transformed from cartesian to cylindrical coordinates, Tₓ:(\hat{ρ}ₚ, \hat{θ}ₚ, \hat{z}ₚ). For example, FIG. 4D shows the electroacoustic telemetry transducer 438 location in the X-Y plane in terms of an angle θₚ and a radius from the origin, ρₚ, overlaid on the nozzle 459 and tubular structure 457 footprints and FIG. 4E shows the electroacoustic telemetry transducer 438 (corresponding to the probe assembly) location in the Y-Z plane in terms of the z-coordinate (with the electroacoustic telemetry transducer 438 location at zₚ), overlaid on the nozzle 459 and tubular structure 457 footprints, Such transformation to cylindrical coordinates may provide a more direct indication of index error or other error for purposes of probe assembly tracking. For example, for cylindrical structures under test such as pipes, vessels, or tubular materials, cylindrical coordinates may be easier to interpret by an operator or may be more suitable for logging of spatially-encoded acquisitions.

In the examples of FIG. 4A, FIG. 4B, FIG. 4C, FIG. 4D, and FIG. 4E, the electroacoustic receiver array 490 is shown as located circumferentially around a nozzle 459. However, electroacoustic receiver transducer elements need not entirely encircle a structure being inspected, or such as receiver array 490 can be modular. A modular receiver array 490 structure can facilitate inspection of nozzles or other structures having different geometries, such as different diameters. For example, FIG. 5A illustrates generally an example comprising a transducer cluster 596 in a modular electroacoustic receiver array. For example, nodes in the cluster can include transducer elements such as an element 591 as shown in FIG. 5A, and respective nodes can be mechanically coupled to each other such as using a tether 594 (e.g., a flexible or elastomeric tether, or an articulating linkage for example). Clusters such as the cluster 596 can be removably mechanically coupled with other clusters, such as using a mating feature. For example, a pin 592A can mate with a receiver 592B or another mechanical interconnect scheme can be used. In an example, if a pin or other similar configuration is used, one cluster 596 can pivot relative to another cluster.

FIG. 5B illustrates generally an example comprising a modular electroacoustic receiver array 590 including multiple clusters 596A, 596B, and 596C, that are mechanically coupled in a chain, such as to provide receivers along at least a portion of a circumference of a structure under test such as a nozzle 559 structure. The array 590 can be anchored to the structure under test, such as using spring force or other tension, such as provided by members coupling elements in the clusters 596A, 596B, or 596C together, or using another approach such as an external band, adhesive, or a mesh or textile housing the clusters 596A, 596B, or 596C or mechanically coupled thereto, as illustrative examples.

Generally, in the examples described in this document, position or orientation determination can be performed using a variety of techniques. For example, acoustic telemetry signals transmitted at or nearby a probe assembly can be received by respective ones of the acoustic receivers located in an array as described above. A time-of-arrival or time-difference-of-arrival (e.g., multilateration) technique can be used. The signaling provided by electroacoustic telemetry transmitter as described in various examples above can have characteristics that are different from signals used for acoustic inspection. For example, inexpensive cylindrical ultrasound transducers such as the transducer element 591 shown in FIG. 5A can be used, such as for transmitting the acoustic telemetry signal and for receiving the transmitted acoustic telemetry signal. For example, such a scheme can use a center frequency of about 40 kilohertz (kHz), such as using a different excitation signal or center frequency as compared to signals used for acoustic inspection. Such excitation can include a chirped waveform, a square or other pulse envelope, a noise signal, or other burst such as a sinusoidal burst signal. Generally, determinations of an acoustic probe position or orientation do not require an a priori model of the receiver locations or test structure geometry. An indexing or calibration operation can be triggered, such as with probe in an initial or reference orientation or location, and position or orientation determinations can be presented relative to such an initial or reference orientation or location.

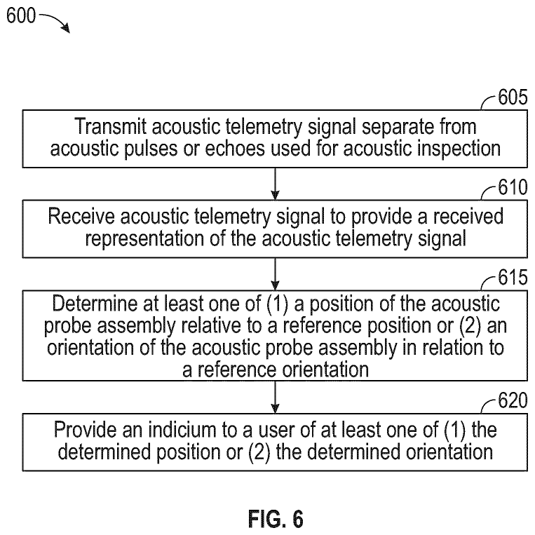

FIG. 6 shows a technique, such as a machine implemented method 600, for determining at least one of a position or an orientation of an acoustic probe assembly. At 605, an acoustic telemetry signal can be transmitted, where the acoustic telemetry signal is separate from acoustic pulses or echoes used for acoustic inspection. For example, as shown and described elsewhere herein, the acoustic telemetry signal can be transmitted by an electroacoustic telemetry transducer that is separate from other electroacoustic transducers used for performing an acoustic inspection acquisition. At 610, the acoustic telemetry signal can be received, such as using one or more electroacoustic receivers, to provide one or a set of respective received representations of the acoustic telemetry signal. As described above, the electroacoustic receiver can include one or more transducer elements at or nearby an inspection probe assembly, or the receiver can include an array of elements, such as located elsewhere. At 615, at least one of a position of the acoustic probe assembly or an orientation of the acoustic probe assembly can be determined, such as in relation to a reference position or a reference orientation. Such determinations can be stored or otherwise logged, such as to provide tracking of probe location or orientation associated with an inspection acquisition (in addition to other spatial encoding, or instead of using other spatial encoding). In an example, at 620, an indicium can be provided to a user, the indicium representing at least one of the determined position or the determined orientation. Other operator feedback techniques can be used, such as discussed above, including haptic or audible feedback, for example. In this manner, tracking guidance can be provided to an operator, such as facilitating free-hand scanning of an acoustic probe assembly for performing acoustic inspection.

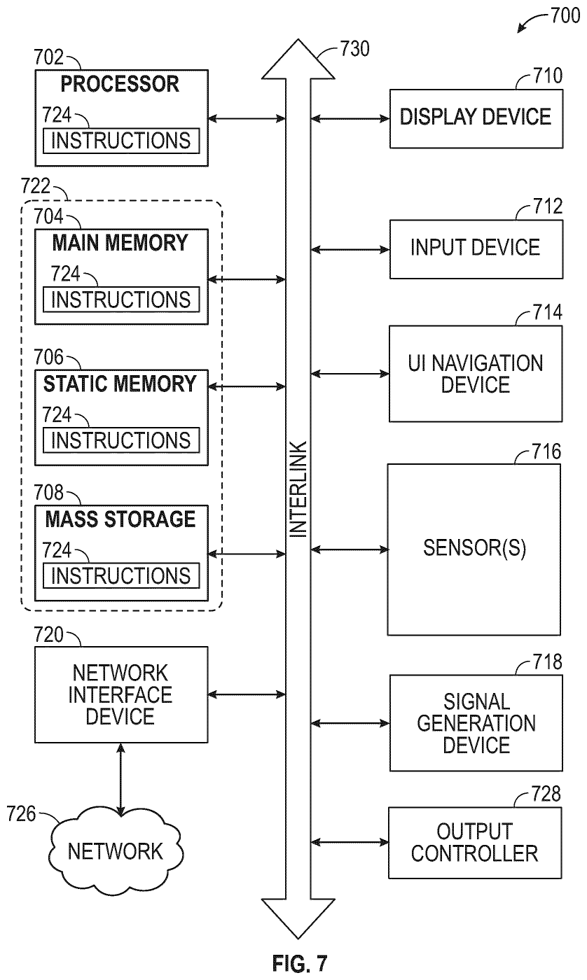

FIG. 7 illustrates a block diagram of an example comprising a machine 700 upon which any one or more of the techniques (e.g., methodologies) discussed herein may be performed. Machine 700 (e.g., computer system) may include a hardware processor 702 (e.g., a central processing unit (CPU), a graphics processing unit (GPU), a hardware processor core, or any combination thereof), a main memory 704 and a static memory 706, connected via an interlink 730 (e.g., link or bus), as some or all of these components may constitute hardware for systems or related implementations discussed above.

Specific examples of main memory 704 include Random Access Memory (RAM), and semiconductor memory devices, which may include storage locations in semiconductors such as registers. Specific examples of static memory 706 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 700 may further include a display device 710, an input device 712 (e.g., a keyboard), and a user interface (UI) navigation device 714 (e.g., a mouse). In an example, the display device 710, input device 712, and UI navigation device 714 may be a touch-screen display. The machine 700 may include a mass storage device 708 (e.g., drive unit), a signal generation device 718 (e.g., a speaker), a network interface device 720, and one or more sensors 716, such as a global positioning system (GPS) sensor, compass, accelerometer, or some other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 708 may comprise a machine-readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the mass storage device 708 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 724.

An apparatus of the machine 700 includes one or more of a hardware processor 702 (e.g., a central processing unit (CPU), a graphics processing unit (GPU), a hardware processor core, or any combination thereof), a main memory 704 and a static memory 706, sensors 716, network interface device 720, antennas, a display device 710, an input device 712, a UI navigation device 714, a mass storage device 708, instructions 724, a signal generation device 718, or an output controller 728. The apparatus may be configured to perform one or more of the methods or operations disclosed herein.

The term “machine readable medium” includes, for example, any medium that is capable of storing, encoding, or carrying instructions for execution by the machine 700 and that cause the machine 700 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 724 may be transmitted or received, for example, over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 720 includes one or more physical jacks (e.g., Ethernet, coaxial, or other interconnection) or one or more antennas to access the communications network 726. In an example, the network interface device 720 includes one or more antennas to wirelessly communicate using at least one of single-input multiple-output (SIMO), multiple-input multiple-output (MIMO), or multiple-input single-output (MISO) techniques. In some examples, the network interface device 720 wirelessly communicates using Multiple User MIMO techniques. The term “transmission medium” shall be taken to include any intangible medium that is capable of storing, encoding or carrying instructions for execution by the machine 700, and includes digital or analog communications signals or other intangible medium to facilitate communication of such software.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An apparatus for acoustic inspection, comprising:
an acoustic probe assembly comprising:
an electroacoustic inspection transducer configured to transmit acoustic pulses for the acoustic inspection and to receive echoes elicited by the acoustic pulses for the acoustic inspection; and
an electroacoustic telemetry transducer configured for transmission of an acoustic telemetry signal separate from acoustic pulses or echoes for the acoustic inspection, the electroacoustic telemetry transducer separate from the electroacoustic inspection transducer; and
at least one electroacoustic receiver configured to receive the acoustic telemetry signal;
a visual indicator;
a processor circuit communicatively coupled with the electroacoustic telemetry transducer and the at least one electroacoustic receiver; and
a memory circuit comprising instructions that when executed by the processor circuit, cause the processor circuit to:
using a received representation of the acoustic telemetry signal, determine at least one of (1) a position of the acoustic probe assembly relative to a reference position or (2) an orientation of the acoustic probe assembly in relation to a reference orientation; and
using the visual indicator, present an indicium to a user of at least one of (1) the determined position or (2) the determined orientation.

2. The apparatus of claim 1, wherein the at least one electroacoustic receiver comprises an electroacoustic receiver included as a portion of the acoustic probe assembly; and
wherein the memory circuit comprises instructions that when executed by the processor circuit, cause the processor circuit to determine the position of the acoustic probe assembly relative to a reference position using a received representation of the acoustic telemetry signal received by the electroacoustic receiver included as a portion of the acoustic probe assembly.

3. The apparatus of claim 1, wherein the at least one electroacoustic receiver comprises two electroacoustic receivers included as a portion of the acoustic probe assembly; and
wherein the memory circuit comprises instructions that when executed by the processor circuit, cause the processor circuit to determine the position and the orientation of the acoustic probe assembly relative to a reference position using respective received representations of the acoustic telemetry signal received by the two electroacoustic receivers included as a portion of the acoustic probe assembly.

4. The apparatus of claim 1, wherein the at least one electroacoustic receiver comprises a plurality of electroacoustic receivers separate from the acoustic probe assembly.

5. The apparatus of claim 4, wherein the plurality of electroacoustic receivers are configured to be anchored to a portion of an object to be inspected by the electroacoustic inspection transducer.

6. The apparatus of claim 5, wherein the plurality of electroacoustic receivers are located around at least a portion of a circumference of the object to be inspected.

7. The apparatus of claim 6, wherein the plurality of electroacoustic receivers are anchored to the object to be inspected.

8. The apparatus of claim 4, wherein the plurality of electroacoustic receivers are modular, comprising at least one electroacoustic receiver assembly that is removably mechanically coupled to at least one other electroacoustic receiver assembly, to accommodate different circumferences of respective objects to be inspected.

9. The apparatus of claim 4, wherein the memory circuit comprises instructions that when executed by the processor circuit, cause the processor circuit to determine the position and the orientation of the acoustic probe assembly relative to a reference position using respective received representations of the acoustic telemetry signal received by the plurality of electroacoustic receivers.

10. The apparatus of claim 4, wherein the memory circuit comprises instructions that when executed by the processor circuit, cause the processor circuit to determine the position and the orientation of the acoustic probe assembly by multilateration using respective received representations of the acoustic telemetry signal received by the plurality of electroacoustic receivers.

11. The apparatus of claim 1, wherein the visual indicator is configured to present an indicium to a user of the determined orientation as an amount of a probe assembly skew relative to a reference orientation.

12. The apparatus of claim 1, wherein the visual indicator is configured to present an indicium to a user of the determined position as an amount of a probe assembly index error relative to a reference orientation.

13. The apparatus of claim 1, wherein the visual indicator comprises a row of display elements; and
wherein the indicium comprises an indicator along the row of display elements.

14. The apparatus of claim 1, comprising a user input to receive an input from a user; and
wherein memory circuit comprises instructions that when executed by the processor circuit, cause the processor circuit to establish at least one of (1) the reference position or (2) the reference orientation in response to the input.

15. The apparatus of claim 1, wherein the acoustic telemetry signal comprises signal characteristics that are different from the acoustic pulses and the received echoes associated with the acoustic inspection.

16.-20. (canceled)

21. A method for acoustic inspection probe guidance, the method comprising:
using an acoustic inspection probe assembly, transmitting an acoustic telemetry signal separate from acoustic pulses or echoes used for acoustic inspection;
using at least one electroacoustic receiver, receiving the acoustic telemetry signal to provide a received representation of the acoustic telemetry signal;
using the received representation of the acoustic telemetry signal, determining at least one of (1) a position of the acoustic probe assembly relative to a reference position or (2) an orientation of the acoustic probe assembly in relation to a reference orientation; and
providing an indicium to a user of at least one of (1) the determined position or (2) the determined orientation.

22. The method of claim 21, wherein the at least one electroacoustic receiver comprises an electroacoustic receiver included as a portion of the acoustic probe assembly.

23. The method of claim 21, wherein the at least one electroacoustic receiver comprises a plurality of electroacoustic receivers separate from the acoustic probe assembly.

24. The method of claim 23, comprising determining the position and the orientation of the acoustic probe assembly by multilateration using respective received representations of the acoustic telemetry signal received by the plurality of electroacoustic receivers.

25. The method of claim 21, wherein the acoustic telemetry signal comprises signal characteristics that are different from the acoustic pulses and the received echoes associated with the acoustic inspection.
